(19) United States
(12) Patent Application Publication
(10) Pub. No.: US 2002/0023228 A1
(43) Pub. Date: Feb. 21, 2002

(54) Method for establishing a data connection between a first and a second computing device and an arrangement for exchanging of data

(76) Inventors: Juergen Schlesinger, Buettelborn (DE); Dieter Rohrdrommel, Maintal (DE); Ralf Ackermann, Darmstadt (DE); Utz Roedig, Darmstadt (DE); Ralf Steinmetz, Seeheim-Jugenheim (DE)

Correspondence Address: STRIKER, STRIKER & STENBY, 103 East Neck Road, Huntington, NY, 11743, US

(21) Appl. No.: 09/933,088

(22) Filed: Aug. 20, 2001

(30) Foreign Application Priority Data
Aug. 18, 2000 (DE) 100 40 463.4

(51) Int. Cl. H04L 9/32; H04L 12/22

(52) U.S. Cl. 713/201; 713/153

(57) ABSTRACT

In a method and an arrangement, data are supplied by a firewall computing device to a further computing device when the firewall computing device can not process the utilized data protocol, and the further computing device takes over the functions of the firewall computing device during testing of the transmitted data pack and during performing the access readiness, wherein a data exchange is established from the further computing device again through the firewall computing device to a protected region, and an increased flexibility of the firewall operation is provided.

### BACKGROUND OF THE INVENTION

The present invention relates to method for establishing a data connection between a first and a second computing device and an arrangement for exchanging of data. In network systems it is conventional to connect an access of an open region, such as for example the Internet, to a close region, such as for example an Intranet through an access computing device. The access computing device represents a connection between the closed region and the outer world. For example, the access computing device is formed as a firewall computer, which tests the access readiness of an external computing device and in the case of the presence of the access readiness allows an access to the closed region. In addition to the access readiness, the access computing device monitors also the establishment of the connection, which is connected to the closed region and filters the data from the data flow which do not satisfy the predetermined parameter. In this way, it is guaranteed that only the correct data are supplied to the closed region.

For providing an access of external computing devices to the closed region, it is necessary that the access computing device cooperates with a plurality of communication protocals. First of all, the formation of the access computing device for a compatibility with many communication protocals is relatively expensive, and on the other hand an expansion of the functionality of the access computing device is relatively expensive, since software components of the access computing device must be changed and/or adapted.

### SUMMARY OF THE INVENTION

Accordingly, it is an object of the present invention to provide method for establishing a data connection between a first and a second computing device and an arrangement for exchanging of data, with which a simple access to a closed region is possible.

In keeping with these objects and with others which will become apparent hereinafter, one feature of present invention resides, briefly stated, in a method of establishing a data connection between a first computing device and a second computing device, comprising the steps of establishing a data connection to a second computing device through a third computing device; supplying from the first computing device a query signal to the third computing device; testing the query signal by the third computing device; supplying by the third computing device, when a predetermined query signal is available, the query signal to a fourth computing device; testing the query signal by the fourth computing device; and establishing by the fourth computing device when a predetermined parameter is available through the third computing device a data connection between the first and the second computing device.

In accordance with another feature of the present invention the arrangement is proposed which has a first computing device; a second computing device; a third computing device connected with said second computing device, said third computing device testing a query signal; a fourth computing device with which said third computing device is connected, said third computing device being formed so that when a predeterminable query signal is present, the query signal is further supplied to said fourth computing device, said fourth computing device being formed so as to test the query signal, and said fourth computing device when a predeterminable parameter is present, establishing through said third computing device a data connection between said first and second computing devices.

Preferably, a further fourth computing device is provided, which is in connection with the access computing device, and the establishment of a data connection and the data connection is maintained through the access computing device to the closed region. In this embodiment it is not necessary that the access computing device can process the communication protocol which is utilized by the external, first computing device. The access computing device transfers the datum from the external, first computing device to the further computing device, which establishes a data connection to a second computing device located inside a closed region, through the access computing device.

Thereby an expansion of the communication protocol, which must contain an access to the closed region, is performed for example by a small configuration change in the access computing device, and the arrangement of the further computing device is possible with a corresponding software for processing of the new communication protocol.

In accordance with a further preferable embodiment, the further computing device performs an access readiness of the external computing device. Also, further tests of the data supplied by the external computing device with respect to a correctness of the data can be performed preferably by the further computing device.

In accordance with a further feature of present invention the access computing device tests an access readiness of the external computing device.

In accordance with a further preferable embodiment of the invention, the access readiness of the external, first computing device is performed by the further computing device and after determining an access readiness a data connection between the external, first computing device and a second computing device is established. The data connection is established from the further computing device through the access computing device without testing by the access computing device of the access readiness of the first computing device.

Preferably, the further computing device changes the target address and sender address contained in a data pack, so that a data exchange between the external, first computing device and the second computing device is performed only through the further computing device. Thereby the further computing device always can output the target address for the first and second computing device, while the data pack which is outputted by the further computing device contains the address of the further computing device as the sender address.

In accordance with a further embodiment of the present invention, the further computing device tests whether the external, first computing device utilizes target addresses as alias names. If this is the case, the further computing device then transmits the data pack to a fifth computing device which is formed as a gatekeeper. The fifth computing device determines, based on the address names, the addresses of the computing device which must speak with the alias names. After determination of the address, the data pack is transmitted to the addressee. This procedure makes possible the processing of data packs which utilize alias names as target addresses. With this preferable embodiment both the fifth computing device and also the further computing device are arranged outside the closed region.

In accordance with a preferable embodiment of the present invention, the further computing device processes data packs in accordance with the communication protocol Q.931 and H.245.

Preferable, a query signal of the external, first computing device is utilized in form of a data pack in accordance with the communication protocol Q.931.

For establishing a data connection, data between the first and the second computing devices are exchanged preferably in accordance with the communication protocol H.245.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing an arrangement of computing devices with a closed region which is connected through an access computing device with the Internet and a second closed zone (DMZ) to a gatekeeper and a proxy-server;

FIG. 2 is a view schematically showing the construction of a data connection through a proxy server;

FIG. 3 is a view illustrating a method of establishing a data connection between a first and a second computing device in which the target addresses of the second computing device is known to the first computing device; and

FIG. 4 is a view showing establishment of a data connection through the proxy server and a gatekeeper.

### DESCRIPTION OF THE PREFERRED EMBODIMENTS

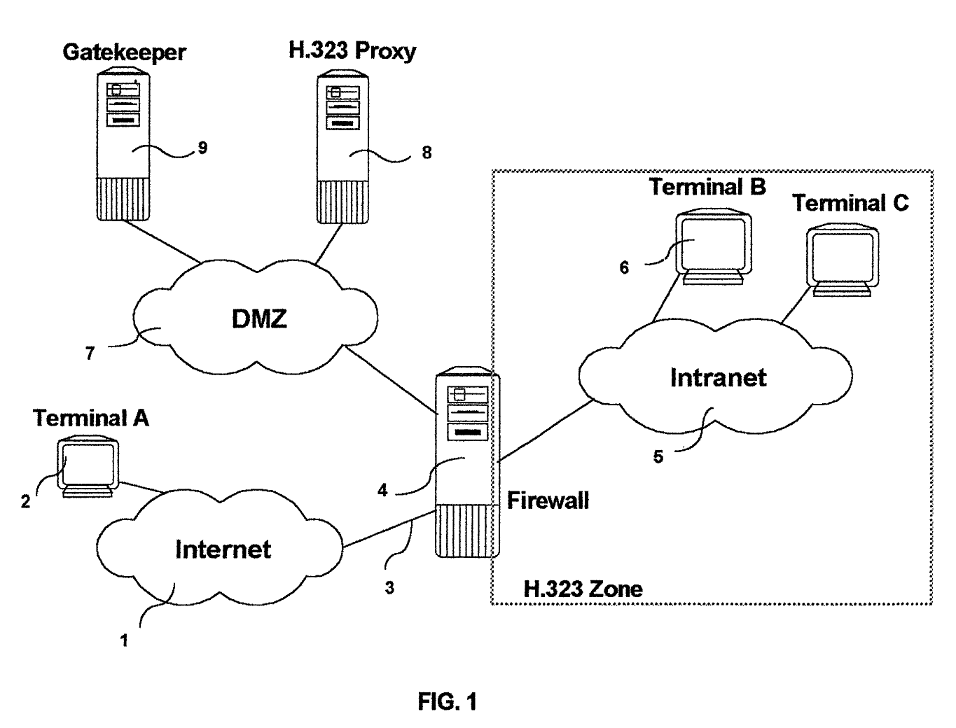

FIG. 1 shows a network with different regions, wherein a first region 1 is an open region, such as for example the Internet. A plurality of computing devices, such as for example a first computing device 2 (terminal A) are connected to the first region 1. The first computing device 2 from the point of view of a second region 5 represents an external computing device.

The first region 1 is connected through a data line 3 with a third computing device 4. The third computing device 4 is also connected to a further region 5 which is formed for example as Intranet. A plurality of computing devices and among them the second computing device 6 are connected with the second region 5.

The third computing device 4 is also connected with a third region 7, to which a fourth computing device 8 and a fifth computing device 9 are connected. The fourth computing device 8 is formed for example as a proxy-server which can process the data in accordance with the communication protocol H.323. The fifth computing device 9 is formed as a gatekeeper, which in a memory has an association table for alias names to IP-address. The third region 7 is formed for example as a local-areanetwork (LAN).

In accordance with a preferable embodiment, the third computing device 4 represents an access computing device which is formed as a firewall computing device, through which an access to the second region 5 is possible. The firewall computing device performs conventionally a testing of the access readiness to the second region 5. In addition, the data packs transmitted to the second region 5 are tested to a correct shape. The third computing device 4 is limited to a predetermined communication protocol. For example, the third computing device 4 can not process the data in form of Internet-telephonic-application, which for example are exchanged in accordance with the H.323 communication protocol.

The fourth computing unit 8 represents a further computing u nit and can for example process data, which are exchanged for Internet telephonic applications and for example transmitted in accordance with the communication protocol H.323.

The third computing device 4 is connected through a software pack with which it can recognize whether the data packs are transmitted in accordance with the communication protocol H.323. If the third computing device 4 determines data with the communication protocol H.323, then these data are transmitted further to the fourth computing unit 8.

Internet telephony is utilized to form a speech connection in correspondence with the classic telephone calling connection. Typical applications and processes use various communication protocols. One of these communication protocols is the H.323 protocol family, which includes the protocol Q.931 and H.245.

The function of the firewall computers first of all resides in securing the second region 5 from the outer worl and allowing readiness to engage the data and/or computing devices of the second region 5 only. For example, for this purpose with pack filters, data packs are tested and only those data packs are transmitted to the second region 5 which have an access readiness. Many firewall computing devices hide also the establishment of the network which is formed in the second region 5. In this embodiment, from outside only the firewall computing device is recognizable.

The first, second and fourth computing devices 2, 6, 8 are formed so that they process data in accordance with the communication protocol H.323, H.245 and Q.931.

In the described embodiment, the third computing device 4 which is formed as a firewall computing device has three interfaces. One interface is connected with the first region 1, the Internet, a second interface is connected with a second region 5, and a third interface is connected with the third region 7, a local-area-network. Instead of an individual, third computing device 4, a plurality of computing devices formed as a firewall system can be arranged.

When the first computing device 2 sends a query to the third computing device 4 to establish an Internet-telephonic connection in accordance with the H.323 standard, then the first computing device 2 outputs a query signal in accordance with the Q.931 standard to the third computing device 4. The third computing device 4 tests the incoming signal and recognizes a query in form of a Q.931 built-up signal. The third computing device 4 therefore transmits the data contained from the first computing device 2 to the fourth computing device 8, which establishes a data connection between the first computing device 2 and a desired second computing device 6 in accordance with the H.323 standard through the third computing device 4. The fourth computing device 4 performs for example a testing of the access readiness and tests the data outputted by the first computing device 2 to a correct form, and performs thereby preferably the monitoring and testing functions of a firewall computer.

In a simple embodiment, all data which are sent from outside, are further transmitted to a testing and an eventual transmission to the fourth computing device 8 or to the fourth and fifth computing device 8, 9.

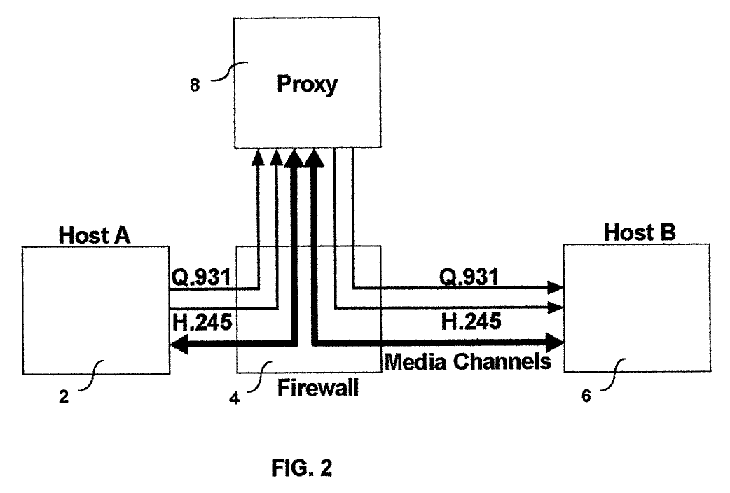

FIG. 2 in form of a schematic diagram shows the path of the data signals which are exchanged after the establishment of an Internet telephonic connection between the first computing device 2 and the second computing device 6. Data are supplied in accordance with the Q.931 from the first computing device 2 through the third computing device 4 to the fourth computing device 8. From the fourth computing device 8, data are transmitted through the third computing device 4 in accordance with the Q.931 standard to the second computing device 6. In addition, data from the first computing device 2 in form of the H.245 standard are transmitted through the third computing device 4 to the fourth computing device 8. From the fourth computing device 8 data in H.245 standard are transmitted through the third computing device 4 to the second computing device 6. Between the first computing device 2 and the second computing device 6, media channels are formed for example in accordance with the UDP standard from the first computing device 2 through the third computing device 4 to the fourth computing device 8 and from the fourth computing device 8 via the third computing device 4 to the second computing device 6.

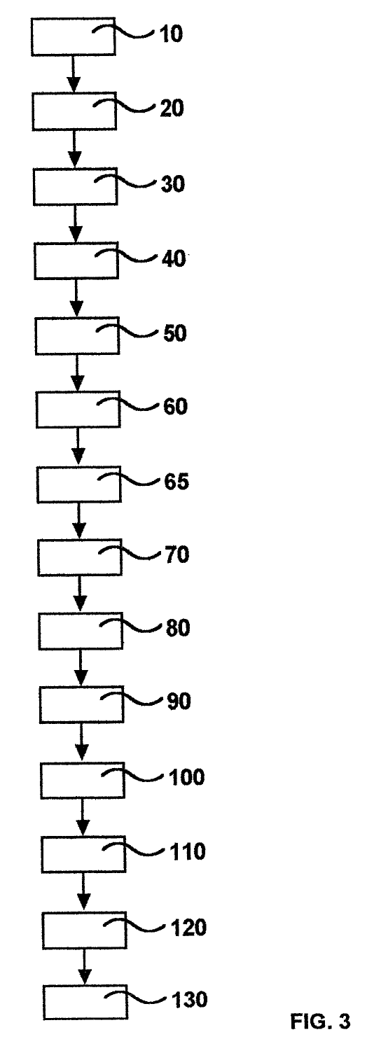

FIG. 3 shows a process flow which illustrates an establishment of the data connection in correspondence with FIG. 2. In a program point 10 the first computing device 2 outputs a query signal in form of the Q.931 standard to the third computing device 4. The third computing device 4 tests the incoming signal and recognizes a signal in accordance with the Q.931 standard in the program point 20. The third computing device 4 tests whether the received data can be processed. Since however the third computing device 4 can not process the data in accordance with the standard H.323, the third computing device 4 at the program point 30 outputs the query signal to the fourth computing device 8.

The fourth computing device 8 detects at the program point 40 the query signal and determines from the query signal the target address, with which a telephonic connection must be established. In the described embodiment the target address is the address of the second computing device 6. Subsequently the fourth computing device 8 changes the sender address at the program point 50 which is contained in the query signal, into the own address and sends the changed query signal through the third computing device 4 to the second computing device 6. Preferably the fourth computing device 8 before the transmission of the query signal to the second computing device 6 performs a testing of the access readiness. Therefore predetermined data regions of the query signal are tested to a corresponding access recognition. If the query signal does not contain any access recognition, a further transmission of the query signal is stopped.

At the following program point 60, the second computing device obtains the query signal. The second computing device 6 at a program point 65 outputs an answer signal in form of a Q.931 format through the third computing device 4 to the fourth computing device 8. The fourth computing device 8 receives at the program point 70 the answer signal and changes both the target address and the sender address of the answer signal. As a target address, the fourth computing device 8 determines the address of the fourth computing device 2 and as a sender address it determines the address of the fourth computing device 8.

At the following program point 80, the fourth computing device 8 sends the changed answer signal in Q.931 standard through the third computing device 4 to the first computing device 2.

At the program point 90, the first computing device 2 evaluates the contained answer signal and determines based on the answer signal whether the second computing device 6 is ready for establishment of a telephonic connection. If this is the case, the first computing device 2 at the program point 9 answers with the establishment signal in form of the H.245 standard. In the establishment signal further parameters for arranging of media channels are contained. 5 The establishment signal is sent through the third computing device 4 to the fourth computing device. The fourth computing device 8 changes both the target address and the sender address of the establishment signal. As a target address, the address of the second computing device and as a sender address the address of the fourth computing device 8 are utilized.

At the following program point 100, the fourth computing device 8 sends the changed establishment signal through the third computing device 4 to the second computing device 6.

In a subsequent program point 110, the second computing device 6 answers in form of a second answer signal in accordance with the H.245 standard, through the third computing device 4 to the fourth computing device 8. The fourth computing device 8 converts again the sender address and the target address and transmits the second answer signal to the first computing device 2. In this manner, data between the first and the second computing devices 2, 6 are exchanged, which is required for an establishment of a media channel.

After the exchange of all required data for establishment media channel, at the program point 120 a media channel is established, for example in form of the UDP protocol. The media channel extends from the first computing device through the third computing device 4 to the fourth computing device 8, and from the fourth computing device 8 through the third computing device 4 to the second computing device 6.

A telephonic connection is established now between the first computing device 2 and the second computing device 6, in form of H.323 standard. Its data can not be processed by the third computing device 4 which is formed as a firewall computing device.

When the telephonic connection is established between the first and the second computing device 2, 6, then at the program point 130 corresponding data signals, such as during establishment of the data connection, are exchanged through the third computing device 4 and the fourth computing device 8.

During the transmission of data between the first and the second computing devices 2, 6, the fourth computing device 8 and/or the third computing device 4 test the form of the data pack in accordance with the predetermined data pack form. Therefore, incorrect data packs are filtered out, and they are filtered out before an access to the second region 5.

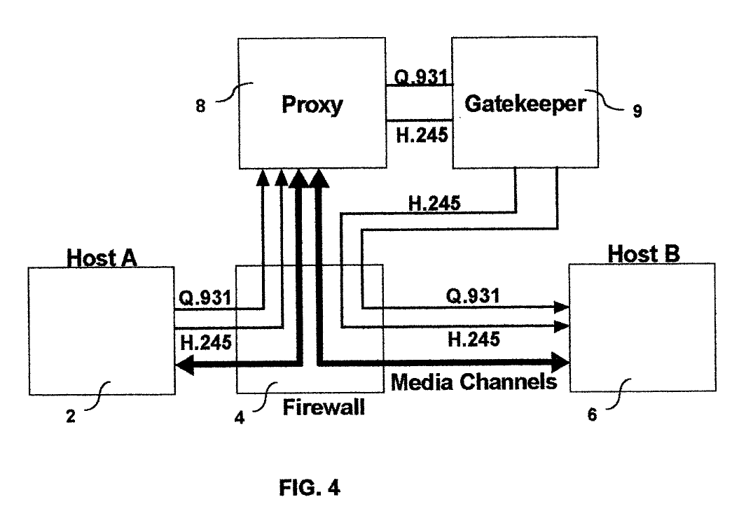

FIG. 4 shows a further embodiment of the invention, in which for the establishment of the data connection, a fifth computing device 9 is used. The fifth computing device 9 is formed as a gatekeeper and is available through a data storage, in which a table for association of alias names to network addresses, such as for example the IP addresses is stored. The query signal in Q.931 standard in correspondence with FIG. 2 is supplied through the third computing device 4 to the fourth computing device 8. The fourth computing device 8 changes the sender address of the contained query signal and writes the own address as the sender address in the query signal. The fourth computing device 8 determines during the testing of the query signal that an alias name is used as the target addresses. Moreover, the fourth computing device 8 transmits the query signal to the fifth computing device 9. The fifth computing device 9 determines, based on the alias names used in the query signal Q.931 the network address of the desired computing device. In the above described embodiment, a telephone connection from the first computing device 2 with the second computing device 6 is desired. Thereby the fifth computing device 9 determines as a target address for the query signal, for example the IP address of the second computing device 6 and transmits the query signal through the third computing device 4 to the second computing device 6.

The answer signal of the second computing device 6 is also supplied through the third computing device 4 and the gatekeeper 9 to the fourth computing device 8.

The fourth computing device 8 changes in correspondence with the process of FIG. 3 for the answer signal, the target address and the sender address. A new target address is the address of the first computing device 2, and a sender address is the address of the fourth computing device 8. The answer signal is also sent from the fourth computing device 8 through the third computing device 4 to the first computing device 2.

The following query signal is in H.245 standard, as in the embodiment of FIGS. 2 and 3 and is transmitted through the third computing device 4 to the fourth computing device 8. The fourth computing device 8 again determines the use of an alias name as a target address. Moreover, the fourth computing device 8 changes the sender address of the establishment signal and transmits the changed establishment signal to the fifth computing device 9. The fifth computing device 9 determines, based on the used alias name, the target address of the desired computing device and sends the establishment signal through the third computing device 4 to the second computing device 6.

After the exchange of corresponding data via the establishment signal, media channels are established from the first computing device 2 through the third computing device 4 to the fourth computing device 8 and starting from the fourth computing device 8 through the third computing device 4 to the second computing device 6. This process corresponds to the process which is utilized in the embodiment of FIGS. 2 and 3.

In the embodiment of FIG. 4, the access readiness and/or the monitoring of the correct form of the data pack is performed for example by the fourth computing device 8. However, at least partial functions of the third computing device 4 or the fifth computing device 9 can be also taken over.

The invention has been described as an example of the establishment of a data connection for transmission of Internet-telephonic data in accordance with the H.323 standard, Q.931 standard, and H.245 standard. The arrangement however is not limited to these data protocols, but instead can be used for each type of data transmission. It is important that the processing, testing, conversion of data, sender addresses and target addresses is performed by a computer device, which is arranged outside a region protected by a firewall computing device. Thereby a simple expansion of the processing of the data protocol via the arrangement of a corresponding computing device is possible, without changing the programming of a firewall computing device. Thereby an increased flexibility of the network and the access readiness to a protected region, for example an Internet is provided.

It will be understood that each of the elements described above, or two or more together, may also find a useful application in other types of methods and constructions differing from the types described above.

While the invention has been illustrated and described as embodied in method for establishing a data connection between a first and a second computing device and an arrangement for exchanging of data, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A method of establishing a data connection between a first computing device and a second computing device, comprising the steps of establishing a data connection to a second computing device through a third computing device; supplying from the first computing device a query signal to the third computing device; testing the query signal by the third computing device; supplying by the third computing device, when a predetermined query signal is available, the query signal to a fourth computing device; testing the query signal by the fourth computing device; and establishing by the fourth computing device when a predetermined parameter is available through the third computing device a data connection between the first and the second computing device.

2. A method as defined in claim 1; and further comprising before the establishing a data connection, testing by the third and/or the fourth computing device an access readiness of the first computing device, and allowing a data connection when the access readiness is provided.

3. A method as defined in claim 2; and further comprising performing by the fourth computing device a testing of the access readiness; establishing a data connection to the second computing device through the third computing device by the fourth computing device when the access readiness is provided; and allowing by the third computing device the data connection between the fourth computing device and the second computing device without testing an access readiness.

4. A method as defined in claim 1; and further comprising providing in the query signal a target address and a sender address; changing by the fourth computing device the sender address into an own address; and sending by the fourth computing device the query signal through the third computing device as the target address.

5. A method as defined in claim 1; and further comprising supplying by the first computing device an establishment signal with a sender address of the first computing device through the third computing device; transmitting by the third computing device the establishment signal to the fourth computing device; converting by the fourth computing device the sender address into an own address and supplying the changed establishment signal through the first computing device to the second computing device as a target address; sending by the second computing device an answer signal to the fourth computing device as a target address through the third computing device; providing in the answer signal as a sender signal the address of the second computing device; changing by the fourth computing device the target address of the answer signal into the address of the first computing device; changing by the fourth computing device the sender address into the address of the fourth computing device; and sending by the fourth computing device subsequently the changed answer signal through the third computing device to the first computing device.

6. A method as defined in claim 1; and further comprising evaluating by the fourth computing device the query signal and recognizing an alias name; transmitting by the fourth computing device the query signal to a fifth computing device; determining by the fifth computing device based on the alias name an address for the second computing device; further transmitting by the fifth computing device the very signal through the third computing device to the address of the second computing device.

7. A method as defined in claim 6; and further comprising supplying by the first computing device an establishment signal to the third computing device; transmitting by the third computing device the establishment signal to the fourth computing device; supplying by the fourth computing device the establishment signal to the fifth computing device; and supplying by the fifth computing device the establishment signal through the third computing device to the second computing device, with exchanging between the first and second computing devices data for establishment a data connection.

8. An arrangement for exchanging data, comprising a first computing device; a second computing device; a third computing device connected with said second computing device, said third computing device testing a query signal; a fourth computing device with which said third computing device is connected, said third computing device being formed so that when a predeterminable query signal is present, the query signal is further supplied to said fourth computing device, said fourth computing device being formed so as to test the query signal, and said fourth computing device when a predeterminable parameter is present, establishing through said third computing device a data connection between said first and second computing devices.

9. An arrangement as defined in claim 8, wherein said computing devices are formed so that data are exchanged between said first and second computing devices through said third and fourth computing devices correspondingly, said fourth computing device changing sender and/or target addresses of the exchanged data.

10. An arrangement as defined in claim 8, wherein said fourth computing device provides a testing of an access readiness of said first computing device for establishing a connection to said second computing device, and said fourth computing device establishes a data connection from said first computing device to said second computing device when the access readiness is established.

11. An arrangement as defined in claim 8; and further comprising a fifth computing device with which said fourth computing device is connected, said fifth computing device performing a conversion of an alias name as a target address which is used by said first computing device into an internal address, said fourth computing device establishing a data connection between said first and second computing devices with a use of an internal address of the second computing device.
